(19) United States
(12) Patent Application Publication
(10) Pub. No.: US 2011/0294005 A1
(43) Pub. Date: Dec. 1, 2011

(54) POWER STORAGE DEVICE, ELECTRODE, AND ELECTRIC DEVICE

(75) Inventors: Kazutaka KURIKI, Ebina (JP); Mikio YUKAWA, Atsugi (JP); Hideki MATSUKURA, Isehara (JP)

(73) Assignee: SEMICONDUCTOR ENERGY LABORATORY CO., LTD., Atsugi-shi (JP)

(21) Appl. No.: 13/102,645

(22) Filed: May 6, 2011

(30) Foreign Application Priority Data
May 28, 2010 (JP) 2010-123139

(51) Int. Cl. H01M 4/02

(52) U.S. Cl. 429/209

(57) ABSTRACT

An object is to improve characteristics of a power storage device by devising the shape of an active material layer. The characteristics of the power storage device can be improved by providing a power storage device including a first electrode, a second electrode, and an electrolyte provided between the first electrode and the second electrode. The second electrode includes an active material layer. The active material layer includes a plurality of projecting portions containing an active material and a plurality of particles containing an active material, which are arranged over the plurality of projecting portions or in a space between the plurality of projecting portions.

### TECHNICAL FIELD

The technical field relates to power storage devices (storage batteries or secondary batteries), electric devices, and the like.

Note that the power storage devices are devices which have at least a function of storing power.

In addition, the electric devices are devices which have at least a function of being driven by electric energy.

### BACKGROUND ART

Patent Document 1 discloses a power storage device which uses an electrode including a film-form active material layer.

### REFERENCE

### Patent Document

[Patent Document 1] Japanese Published Patent Application No. 2001-210315

### DISCLOSURE OF INVENTION

In Patent Document 1, the shape of the active material layer is not devised at all.

In view of the above, a first object is to provide a means for improving characteristics of a power storage device by devising the shape of an active material layer.

A second object is to provide a novel electric device.

Note that the invention disclosed below achieves at least either the first object or the second object.

It is preferable to use an active material layer which includes a plurality of projecting portions containing an active material.

In addition, it is preferable to use an active material layer which includes a plurality of projecting portions containing an active material and a plurality of particles containing an active material, which are arranged over the plurality of projecting portions or in a space between the plurality of projecting portions.

That is, it is possible to provide a power storage device which includes a first electrode, a second electrode, and an electrolyte provided between the first electrode and the second electrode, wherein the second electrode includes an active material layer which includes a plurality of projecting portions containing an active material.

In the above power storage device, it is preferable that the active material layer include a plurality of particles containing an active material, which are arranged over the plurality of projecting portions or in a space between the plurality of projecting portions.

In the above power storage device, it is preferable that some of the plurality of particles are particles formed by breaking some of the plurality of projecting portions.

In the above power storage device, it is preferable that the plurality of projecting portions and the plurality of particles be covered with a protective film containing an active material or a metal material.

In the above power storage device, it is preferable that the shapes of the plurality of projecting portions be uneven.

In the above power storage device, it is preferable that some of the plurality of projecting portions be broken locally.

The above power storage device preferably includes a surface containing an active material in a space between the plurality of projecting portions.

In addition, the power storage device is preferably included in an electric device.

In addition, it is possible to provide an electrode which is used in a power storage device and includes an active material layer which includes a plurality of projecting portions containing an active material.

In the above electrode, it is preferable that the active material layer include a plurality of particles containing an active material, which are arranged over the plurality of projecting portions or in a space between the plurality of projecting portions.

In the above electrode, it is preferable that some of the plurality of particles are particles formed by breaking some of the plurality of projecting portions.

In the above electrode, it is preferable that the plurality of projecting portions and the plurality of particles be covered with a protective film containing an active material or a metal material.

In the above electrode, it is preferable that the shapes of the plurality of projecting portions be uneven.

In the above electrode, it is preferable that some of the plurality of projecting portions be broken locally.

The above electrode preferably includes a surface containing an active material in a space between the plurality of projecting portions.

By using an active material layer which includes a plurality of projecting portions containing an active material, characteristics of a power storage device can be improved.

By using an active material layer which includes a plurality of projecting portions containing an active material and a plurality of particles containing an active material, which are arranged over the plurality of projecting portions or in a space between the plurality of projecting portions, characteristics of a power storage device can be improved.

### BRIEF DESCRIPTION OF DRAWINGS

FIGS. 1A and 1B illustrate an example of an electrode.

FIGS. 2A to 2C illustrate an example of a method for manufacturing an electrode.

FIGS. 3A and 3B illustrate an example of an electrode.

FIGS. 4A to 4C illustrate an example of a method for manufacturing an electrode.

FIGS. 5A and 5B illustrate an example of a method for manufacturing an electrode.

FIGS. 6A and 6B illustrate an example of a method for manufacturing an electrode.

FIGS. 7A and 7B illustrate an example of an electrode.

FIGS. 8A and 8B illustrate an example of an electrode.

FIGS. 9A and 9B illustrate an example of an electrode.

FIGS. 10A and 10B illustrate an example of an electrode.

FIGS. 11A and 11B illustrate an example of an electrode.

FIG. 12 illustrates an example of a method for manufacturing an electrode.

FIGS. 13A and 13B each illustrate an example of a method for manufacturing an electrode.

FIGS. 14A and 14B each illustrate an example of a method for manufacturing an electrode.

FIGS. 15A to 15C illustrate examples of a method for manufacturing an electrode.

FIGS. 16A and 16B illustrate an example of a power storage device.

FIG. 17 shows an example of an electrode (an electron microscope image).

FIGS. 18A and 18B each illustrate an example of an electric device.

FIG. 19 illustrates an example of a power storage device.

FIGS. 20A and 20B each illustrate an example of an electric propulsion vehicle.

### BEST MODE FOR CARRYING OUT THE INVENTION

Embodiments and examples will be described in detail with reference to the drawings.

It is easily understood by those skilled in the art that modes and details thereof can be modified in various ways without departing from the spirit and scope of the present invention.

Therefore, the present invention should not be interpreted as being limited to what is described in the embodiments below.

In structures given below, the same portions or portions having similar functions are denoted by the same reference numerals in different drawings, and explanation thereof will not be repeated.

The following embodiments can be combined with each other as appropriate.

### Embodiment 1

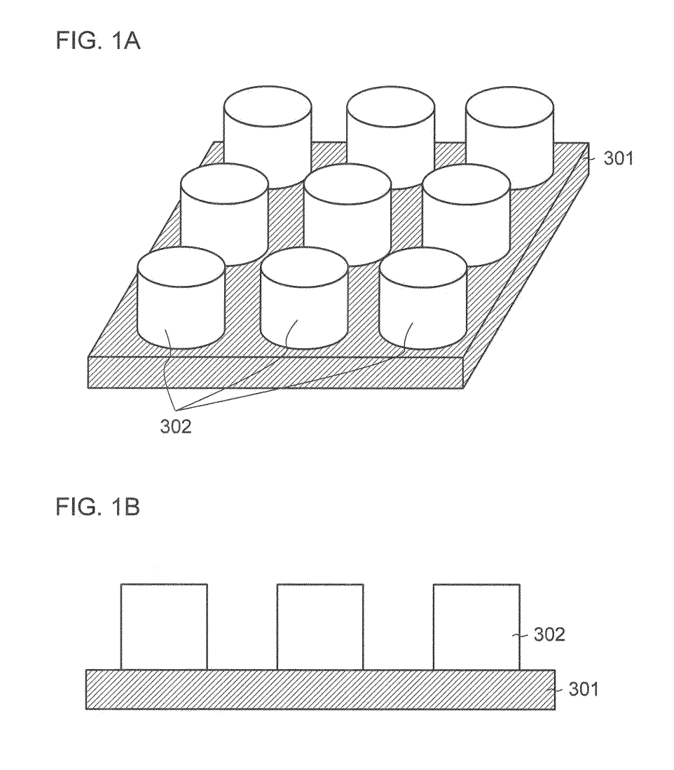

FIG. 1A is a perspective view of an electrode, and FIG. 1B is a cross-sectional view of FIG. 1A.

In FIGS. 1A and 1B, over a current collector 301, a layer 302 containing silicon as a main component, which is formed of a plurality of projecting portions, is formed. Here, in FIGS. 1A and 1B, the layer 302 containing silicon as a main component is an active material layer.

By forming the layer containing silicon as a main component, which is formed of a plurality of projecting portions, a space is formed between one projecting portion and another projecting portion (a space is formed between the plurality of projecting portions), so that cycle characteristics can be improved. In addition, the space has the advantage that the active material layer absorbs an electrolyte solution easily so that a battery reaction occurs easily.

Occlusion of an alkali metal or an alkaline earth metal causes volume expansion of the active material layer, and release of an alkali metal or an alkaline earth metal causes volume contraction of the active material layer.

Here, degrees of degradation of an electrode due to repetitive volume expansion and contraction are referred to as the cycle characteristics.

The space formed between one projecting portion and another projecting portion (the space formed between the plurality of projecting portions) can reduce effects of the volume expansion and contraction, so that the cycle characteristics are improved.

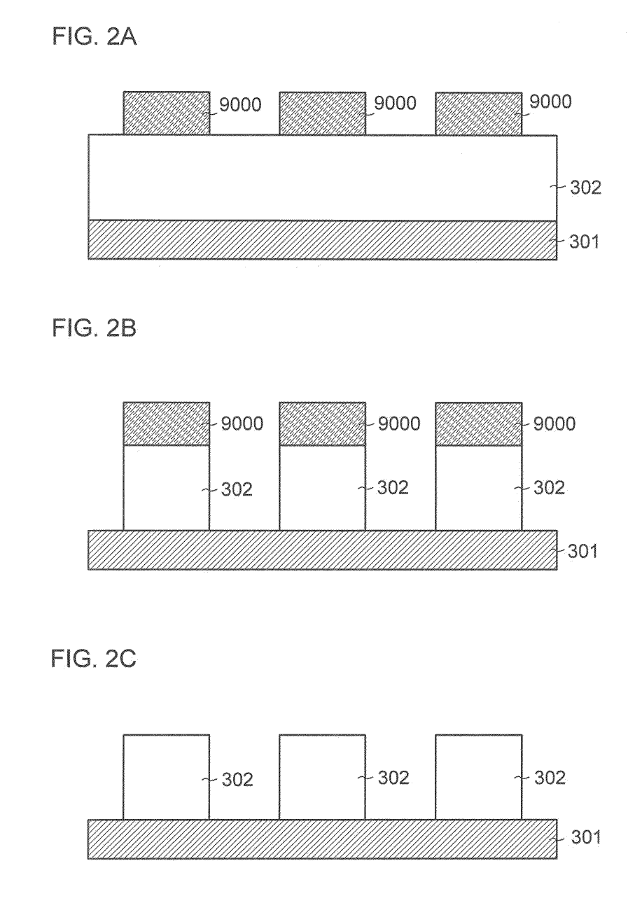

Next, an example of a method for manufacturing the electrode illustrated in FIGS. 1A and 1B is described with reference to FIGS. 2A to 2C.

First, the layer 302 containing silicon as a main component, which has a film form, is formed over the current collector 301, and then a mask 9000 is formed over the layer 302 containing silicon as a main component (FIG. 2A).

Then, part of the film-form layer 302 containing silicon as a main component is processed by etching using the mask 9000, so that the layer 302 containing silicon as a main component, which is formed of a plurality of projecting portions, is formed (FIG. 2B).

Next, the mask 9000 is removed (FIG. 2C).

In the above manner, by using the layer containing silicon as a main component, which is formed of a plurality of projecting portions, characteristics of a power storage device can be improved.

Although the shape of the projecting portions in this embodiment is a cylinder shape, the shape of the projecting portions is not limited thereto.

Examples of the shape include, but are not limited to, a needle shape, a cone shape, a pyramid shape, and a columnar shape (a cylinder shape or a prism shape).

The plurality of projecting portions do not necessarily have the same length.

The plurality of projecting portions do not necessarily have the same volume.

The plurality of projecting portions do not necessarily have the same shape.

The plurality of projecting portions do not necessarily have the same inclination.

This embodiment can be implemented in combination with any of the other embodiments and an example as appropriate.

### Embodiment 2

A means for increasing the surface area of an active material layer as compared to the surface area in Embodiment 1 will be described.

“Increasing the surface area of an active material layer” means that the area where an alkali metal or an alkaline earth metal can enter or exit is increased.

By increasing the area where an alkali metal or an alkaline earth metal can enter or exit, the rate at which an alkali metal or an alkaline earth metal is occluded and released (the occlusion rate and the release rate) is increased.

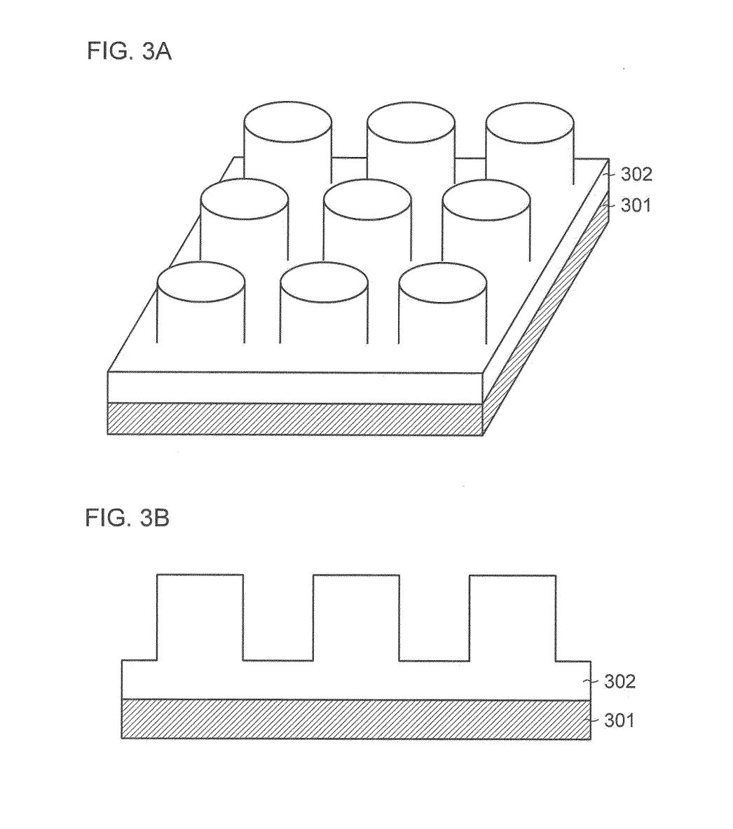

Specifically, a structure illustrated in FIGS. 3A and 3B is preferable.

FIG. 3A is a perspective view of an electrode, and FIG. 3B is a cross-sectional view of FIG. 3A.

In FIGS. 3A and 3B, over the current collector 301, the layer 302 containing silicon as a main component is formed.

In FIGS. 3A and 3B, the layer 302 containing silicon as a main component is an active material layer.

The layer 302 containing silicon as a main component, which is illustrated in FIGS. 3A and 3B, includes a plurality of projecting portions and has a surface containing silicon as a main component (a surface containing an active material) in a space between the plurality of projecting portions.

In other words, the layer 302 containing silicon as a main component has a sheet form in a lower portion and a plurality of projecting portions in an upper portion.

In other words, the layer 302 containing silicon as a main component includes a film-form layer and a plurality of projecting portions that project from a surface of the film-form layer.

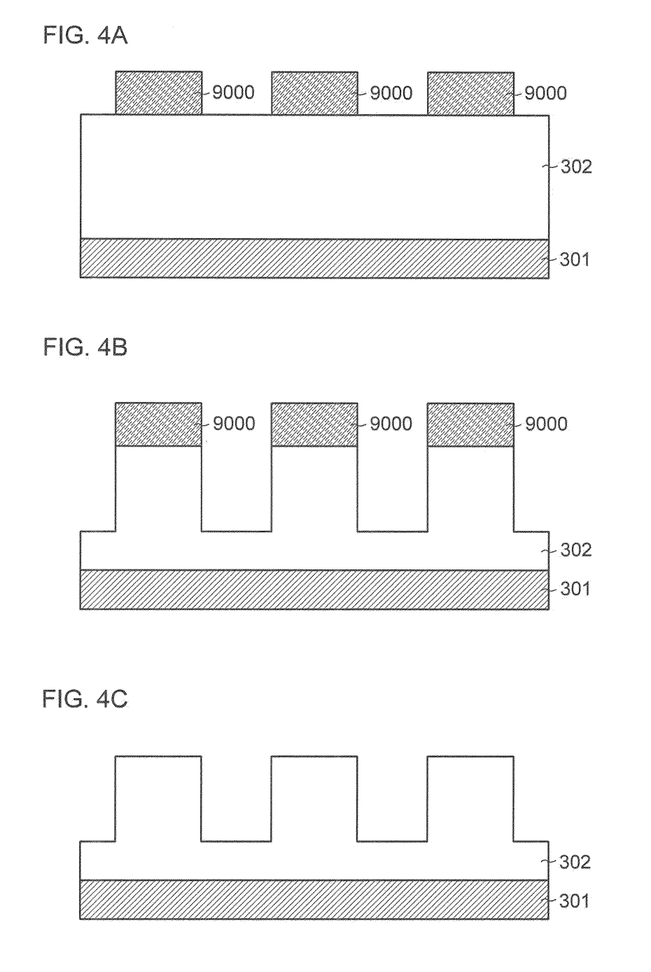

Next, an example of a method for manufacturing the electrode illustrated in FIGS. 3A and 3B is described with reference to FIGS. 4A to 4C.

First, the layer 302 containing silicon as a main component, which has a film form, is formed over the current collector 301, and then the mask 9000 is formed over the layer 302 containing silicon as a main component (FIG. 4A).

Then, part of the film-form layer 302 containing silicon as a main component is processed by etching using the mask 9000, so that the layer 302 containing silicon as a main component, which includes a plurality of projecting portions, is formed (FIG. 4B).

Although FIG. 2B illustrates the example in which the film-form layer 302 containing silicon as a main component is etched until a surface of the current collector is exposed, FIG. 4B illustrates an example in which the etching is stopped so that the layer containing silicon as a main component remains in a space between the plurality of projecting portions.

Next, the mask 9000 is removed (FIG. 4C).

In the above manner, by making the layer containing silicon as a main component remain in a space between the plurality of projecting portions, the surface area of the active material layer can be increased.

In addition, since the layer containing silicon as a main component remains in a space between the plurality of projecting portions, the volume of the active material layer is larger than that in the case where the layer containing silicon as a main component does not remain.

Further, the total volume of the active material layer is also increased, so that the charge and discharge capacity of the electrode can be increased.

Although the shape of the projecting portions in this embodiment is a cylinder shape, the shape of the projecting portions is not limited thereto.

Examples of the shape include, but are not limited to, a needle shape, a cone shape, a pyramid shape, and a columnar shape (a cylinder shape or a prism shape).

The plurality of projecting portions do not necessarily have the same length.

The plurality of projecting portions do not necessarily have the same volume.

The plurality of projecting portions do not necessarily have the same shape.

The plurality of projecting portions do not necessarily have the same inclination.

This embodiment can be implemented in combination with any of the other embodiments and an example as appropriate.

### Embodiment 3

A means for increasing the surface area of an active material layer in Embodiment 1 or Embodiment 2 will be described.

By increasing the surface area of the active material layer, the rate at which the alkali metal or an alkaline earth metal is occluded and released (the occlusion rate and the release rate) can be increased.

Specifically, recessed portions may be formed on side surfaces of the plurality of projecting portions.

In other words, the plurality of projecting portions may have an overhang.

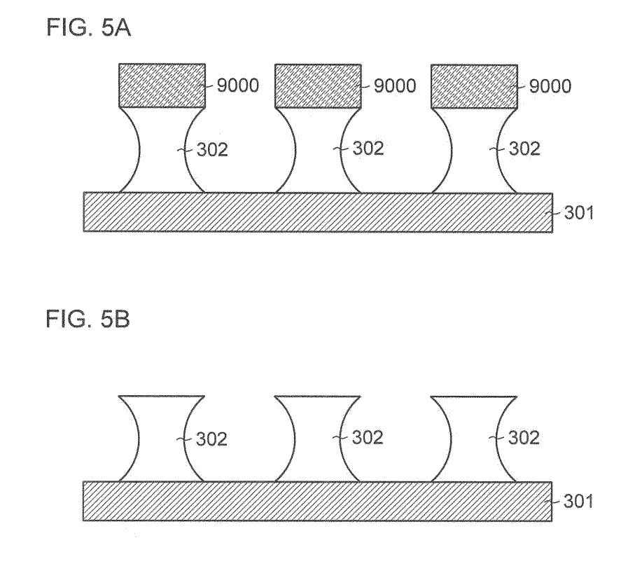

For example, after the step illustrated in FIG. 2B, isotropic etching is performed so that the side surfaces of the plurality of projecting portions are recessed (FIG. 5A).

Next, the mask 9000 is removed (FIG. 5B).

By using the structure illustrated in FIGS. 5A and 5B, the recessed portions are formed on the side surfaces of the plurality of projecting portions, so that the surface area of the active material layer can be increased.

Note that types of etching include anisotropic etching and isotropic etching.

In anisotropic etching, etching proceeds in one direction.

In isotropic etching, etching proceeds in every direction.

For example, anisotropic etching can be performed by dry etching using plasma or the like, and isotropic etching can be performed by wet etching using an etchant or the like.

Even when dry etching is employed, isotropic etching can be performed by adjusting etching conditions.

That is, after anisotropic etching is performed (FIG. 2B), isotropic etching may be performed in the state where the mask 9000 remains (FIG. 5A).

Another example is described below.

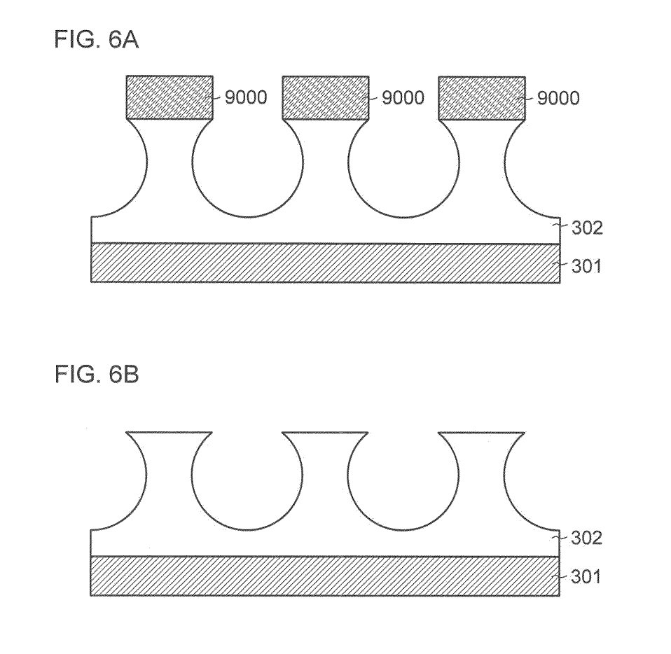

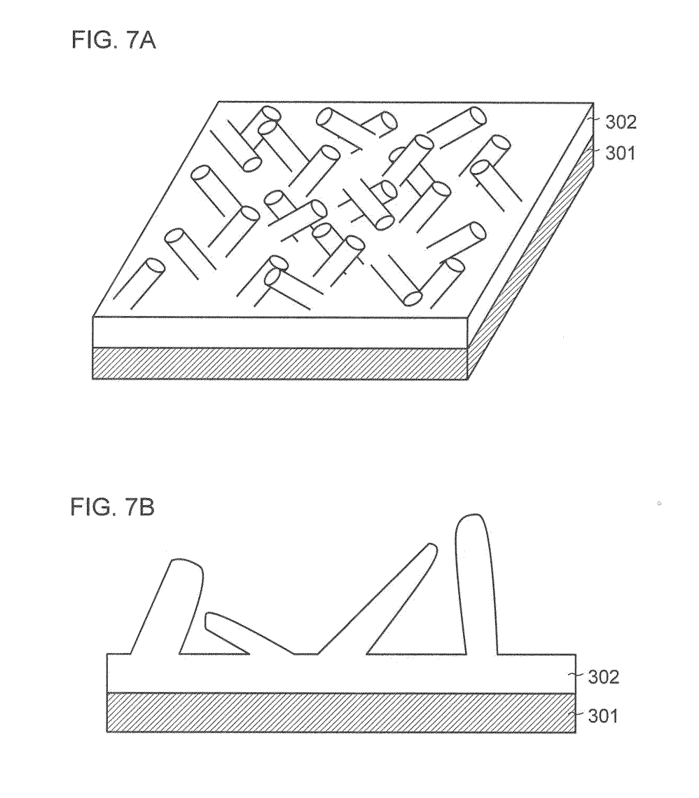

For example, after the step illustrated in FIG. 4B, isotropic etching is performed so that the side surfaces of the plurality of projecting portions and a surface containing silicon as a main component (a surface containing an active material), which is positioned in a space between the plurality of projecting portions, are recessed (FIG. 6A).

Next, the mask 9000 is removed (FIG. 6B).

By using the structure illustrated in FIGS. 6A and 6B, recessed portions are formed on the side surfaces of the plurality of projecting portions and the surface containing silicon as a main component (the surface containing the active material) in a space between the plurality of projecting portions; thus, the surface area of the active material layer can be increased.

This embodiment can be implemented in combination with any of the other embodiments and an example as appropriate.

### Embodiment 4

FIGS. 7A and 7B illustrate an example in which the shapes of the plurality of projecting portions are uneven (irregular).

Note that “the shapes of the plurality of projecting portions are uneven (irregular)” means, for example, one or more of the following. The plurality of projecting portions have different shapes, the plurality of projecting portions have different inclinations in a direction perpendicular to a surface of a current collector, the plurality of projecting portions have different inclinations in a direction parallel to the surface of the current collector, the plurality of projecting portions have different volumes, and the like.

Here, FIG. 7A is a perspective view of an electrode, and FIG. 7B is a cross-sectional view of FIG. 7A.

In FIGS. 7A and 7B, over the current collector 301, the layer 302 containing silicon as a main component is formed.

In FIGS. 7A and 7B, the layer 302 containing silicon as a main component is an active material layer.

The layer 302 containing silicon as a main component, which is illustrated in FIGS. 7A and 7B, includes a plurality of projecting portions and has a surface containing silicon as a main component (a surface containing an active material) in a space between the plurality of projecting portions.

In other words, the layer 302 containing silicon as a main component has a sheet form in a lower portion and a plurality of projecting portions in an upper portion.

In other words, the layer 302 containing silicon as a main component includes a film-form layer and a plurality of projecting portions that project from a surface of the film-form layer.

By employing the structure illustrated in FIGS. 7A and 7B, the surface area of the active material layer can be larger than that in Embodiment 1, as in Embodiment 2.

Further, by employing the structure illustrated in FIGS. 7A and 7B, the volume of the active material layer can be larger than that in Embodiment 1, as in Embodiment 2.

The long-axis direction of the plurality of projecting portions in FIGS. 3A and 3B is perpendicular to the surface of the current collector, whereas the long-axis direction of the plurality of projecting portions in FIGS. 7A and 7B is oblique to the surface of the current collector.

Here, for example, when a check is conducted to see whether a process for manufacturing a product has a problem, whether somebody's product infringes on a patent, or the like, a cross-section of a predetermined portion is sometimes observed by a transmission electron microscope (TEM) or a scanning transmission electron microscope (STEM).

When the cross-section is observed by a TEM or a STEM, elements contained in the observed portion can be specified with an energy dispersive X-ray spectrometry (EDX).

In addition, when the cross-section is observed by a TEM or a STEM, a crystal structure in the observed portion can be specified by an electron diffraction method.

Therefore, a check of part of a product enables failure analysis of the product.

In addition, for example, when a patentee has a patent of an active material layer containing a specific element, the patentee can check whether somebody's product infringes on the patent by observing a cross-section of the product with an energy dispersive X-ray spectrometry (EDX).

In addition, for example, when a patentee has a patent of an active material layer having a specific crystal structure, the patentee can check whether somebody's product infringes on the patent by observing a cross-section of the product by an electron diffraction method.

Although a variety of checks can be conducted by a TEM or a STEM as described above, when a cross-section is analyzed by a TEM or a STEM, a sample needs to be processed to be as thin as possible (100 nm or less).

When the long-axis direction of the plurality of projecting portions is perpendicular) (90° to the surface of the current collector as in FIGS. 1A and 1B, FIGS. 3A and 3B, and the like, there is a problem in that the sample is difficult to process and processing accuracy of the sample is low.

On the other hand, when the long-axis direction of the plurality of projecting portions is oblique (greater than 0° and less than 90°) to the surface of the current collector as in FIGS. 7A and 7B, the sample is easy to process and processing accuracy of the sample is high.

As the projecting portions are more oblique (as the angle formed by the projecting portions and the surface of the current corrector is smaller), the process becomes easier. Therefore, the angle formed by the projecting portions and the surface of the current corrector is preferably 45° or less, more preferably 30° or less.

Next, a method for manufacturing the structure illustrated in FIGS. 7A and 7B is described.

First, a titanium layer, a nickel layer, or the like is prepared as the current collector 301.

Then, the layer 302 containing silicon as a main component is formed by a thermal CVD method.

Note that for the thermal CVD method, a gas containing silicon atoms is preferably used as a source gas at higher than or equal to 550° C. and lower than or equal to 1100° C. (preferably, higher than or equal to 600° C. and lower than or equal to 800° C.).

Examples of the gas containing silicon atoms include, but are not limited to, SiH₄, Si₂H₆, SiF₄, SiCl₄, and Si₂Cl₆.

Note that the source gas may further contain a rare gas (e.g., helium or argon), hydrogen, or the like.

This embodiment can be implemented in combination with any of the other embodiments and an example as appropriate.

### Embodiment 5

Materials for a current collector, a layer containing silicon as a main component, a mask, and the like will be described.

[symbol]

Current Collector

[symbol]

The current collector can be formed using a conductive material.

Examples of the conductive material include, but are not limited to, a metal, carbon, and a conductive resin.

Examples of the metal include, but are not limited to, titanium, nickel, copper, zirconium, hafnium, vanadium, tantalum, chromium, molybdenum, tungsten, cobalt, and an alloy of any of these metals.

[symbol]

Layer Containing Silicon as Main Component

[symbol]

The layer containing silicon as a main component may be any layer as long as the main component is silicon, and may contain another element (e.g., phosphorus, arsenic, carbon, oxygen, nitrogen, germanium, or a metal element) in addition to silicon.

A film-form layer containing silicon as a main component can be formed by, without limitation, a thermal CVD method, a plasma CVD method, a sputtering method, an evaporation method, or the like.

Note that the layer containing silicon as a main component may have any crystallinity.

Note that an element imparting one conductivity type is preferably added to the layer containing silicon as a main component because the conductivity of the active material layer is increased.

Examples of the element imparting one conductivity type include phosphorus and arsenic. The element can be added by, without limitation, an ion implantation method, an ion doping method, a thermal diffusion method, or the like.

Note that a layer containing carbon as a main component may be used instead of the layer containing silicon as a main component.

In addition, the layer containing carbon as a main component may further contain another element.

Note that a material containing silicon as a main component, a material containing carbon as a main component, or the like is an active material.

Note that the active material is not limited to silicon and carbon as long as the material can occlude or release an alkali metal or an alkaline earth metal.

[symbol]

Mask

[symbol]

An example of the mask is, without limitation, a photoresist mask.

This embodiment can be implemented in combination with any of the other embodiments and an example as appropriate.

### Embodiment 6

A means for increasing the surface area and the volume of an active material layer will be described.

By increasing the surface area of the active material layer, the rate at which the alkali metal or an alkaline earth metal is occluded and released (the occlusion rate and the release rate) can be increased.

In addition, the total volume of the active material layer is also increased, so that the charge and discharge capacity of an electrode can be increased.

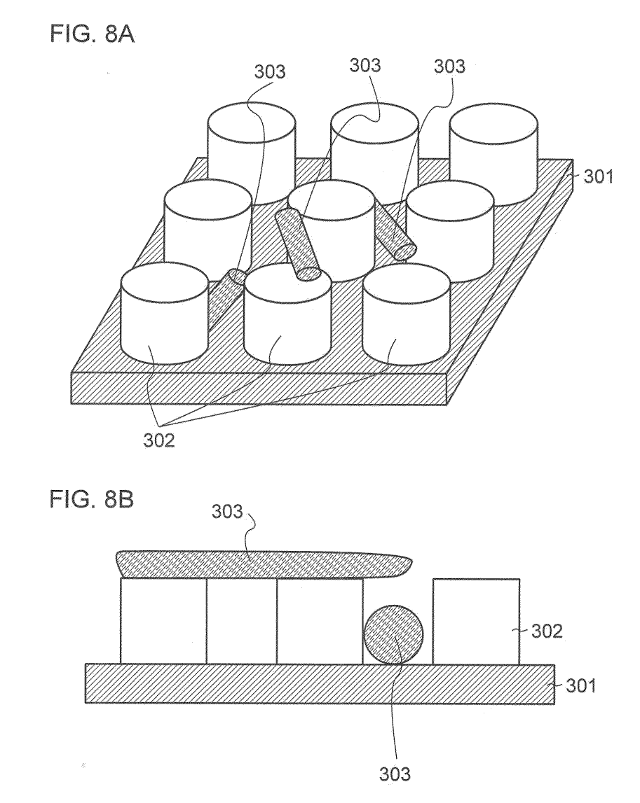

FIGS. 8A and 8B illustrate an example in which a plurality of particles 303 containing silicon as a main component (a plurality of particles 303 containing an active material) are arranged in the structure illustrated in FIGS. 1A and 1B.

Here, FIG. 8A is a perspective view of an electrode, and FIG. 8B is a cross-sectional view of FIG. 8A.

In addition, in FIGS. 8A and 8B, the plurality of particles are arranged over a plurality of projecting portions or in a space between the plurality of projecting portions.

Further, in FIGS. 8A and 8B, the plurality of particles function as the active material layer because the plurality of particles are in contact with the current collector 301 or the layer 302 containing silicon as a main component.

That is, although the active material layer in FIGS. 1A and 1B is formed using only the layer 302 containing silicon as a main component, the active material layer in FIGS. 8A and 8B is formed using the layer 302 containing silicon as a main component and the plurality of particles 303.

Thus, the surface area and the volume of the active material layer in FIGS. 8A and 8B are larger than those in FIGS. 1A and 1B.

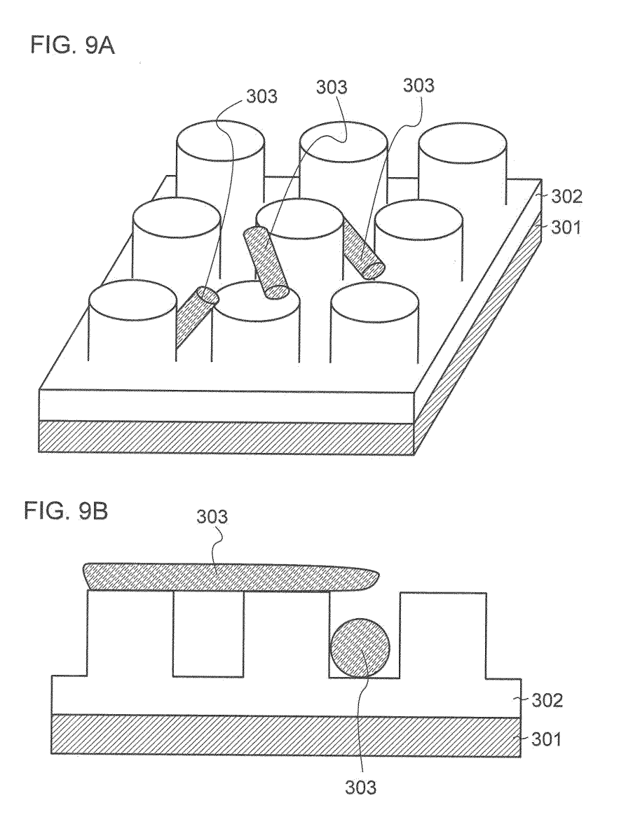

FIGS. 9A and 9B illustrate an example in which the plurality of particles 303 containing silicon as a main component (the plurality of particles 303 containing an active material) are arranged in the structure illustrated in FIGS. 3A and 3B.

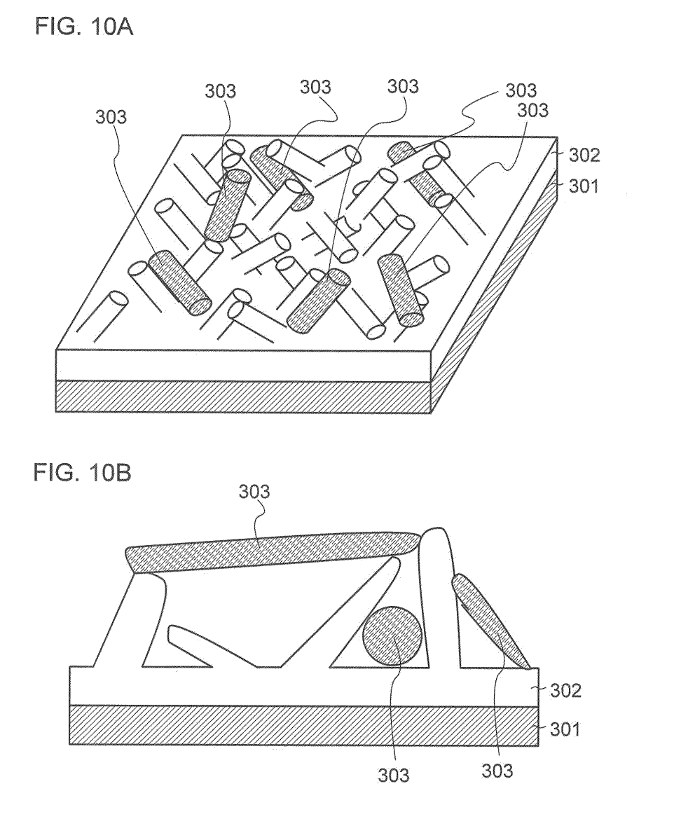

In addition, FIGS. 10A and 10B illustrate an example in which the plurality of particles 303 containing silicon as a main component (the plurality of particles 303 containing an active material) are arranged in the structure illustrated in FIGS. 7A and 7B.

Here, FIG. 9A is a perspective view of an electrode, and FIG. 9B is a cross-sectional view of FIG. 9A.

In addition, FIG. 10A is a perspective view of an electrode, and FIG. 10B is a cross-sectional view of FIG. 10A.

In addition, in FIGS. 9A and 9B and FIGS. 10A and 10B, the plurality of particles are arranged over the plurality of projecting portions or in a space between the plurality of projecting portions.

Further, in FIGS. 9A and 9B and FIGS. 10A and 10B, the plurality of particles function as the active material layer because the plurality of particles are in contact with the layer 302 containing silicon as a main component.

That is, although the active material layer in FIGS. 3A and 3B is formed using only the layer 302 containing silicon as a main component, the active material layer in FIGS. 9A and 9B is formed using the layer 302 containing silicon as a main component and the plurality of particles 303.

In addition, although the active material layer in FIGS. 7A and 7B is formed using only the layer 302 containing silicon as a main component, the active material layer in FIGS. 10A and 10B is formed using the layer 302 containing silicon as a main component and the plurality of particles 303.

Thus, the surface area and the volume of the active material layer in FIGS. 9A and 9B are larger than those in FIGS. 3A and 3B.

In addition, the surface area and the volume of the active material layer in FIGS. 10A and 10B are larger than those in FIGS. 7A and 7B.

Note that in the example of FIGS. 8A and 8B, the plurality of particles 303 containing silicon as a main component are arranged in a space between the plurality of projecting portions and are also in contact with the current collector 301. On the other hand, in the examples of FIGS. 9A and 9B and FIGS. 10A and 10B, the plurality of particles 303 containing silicon as a main component are arranged in a space between the plurality of projecting portions and are not in contact with the current collector 301, but are in contact only with the layer 302 containing silicon as a main component.

Since the same kinds of materials are in contact with each other, the contact resistance between the plurality of particles 303 containing silicon as a main component and the layer 302 containing silicon as a main component is lower than the contact resistance between the plurality of particles 303 containing silicon as a main component and the current collector 301.

That is, the examples of FIGS. 9A and 9B and FIGS. 10A and 10B have effects of reducing the contact resistance as compared with the example of FIGS. 8A and 8B.

When a power storage device is manufactured using a liquid electrolyte, the liquid electrolyte eventually comes in contact with a surface of an electrode, so that there is a concern for a problem in that the plurality of particles disperse in the liquid electrolyte and are not in contact with the layer containing silicon as a main component.

However, by finally fixing the plurality of particles by a separator, the plurality of particles can be prevented from dispersing in the liquid electrolyte.

Alternatively, by using a gel-like electrolyte or a solid electrolyte, the plurality of particles can be fixed by the gel-like electrolyte or the solid electrolyte.

On the other hand, when the separator is not provided, there is a problem in that the plurality of particles cannot be fixed by the separator.

In addition, even when the plurality of particles are fixed by the separator, the gel-like electrolyte, the solid electrolyte, or the like, there is another problem in that some of the plurality of particles are not in contact with the layer containing silicon as a main component and the number of particles functioning as the active material layer decreases in some cases.

Adverse effects of the above problems are significant in the examples of FIGS. 8A and 8B and FIGS. 9A and 9B in which the shapes of the plurality of projecting portions are uniform (regular).

However, adverse effects of the above problems can be reduced in the example of FIGS. 10A and 10B in which the shapes of the plurality of projecting portions are uneven (irregular).

That is, in the example of FIGS. 10A and 10B, there are particles under two or more projecting portions which are inclined obliquely.

As a result, two or more projecting portions, which are inclined obliquely, hold the underlying particles.

Therefore, in the example of FIGS. 10A and 10B, adverse effects of the above problems can be reduced.

Note that when two or more projecting portions are inclined in one direction, the plurality of particles are unlikely to be tangled in these projecting portions; thus, it is important that two or more projecting portions are inclined in different directions.

In short, the example of FIGS. 10A and 10B in which the shapes of the plurality of projecting portions are uneven (irregular) is preferable to the examples of FIGS. 8A and 8B and FIGS. 9A and 9B in which the shapes of the plurality of projecting portions are uniform (regular) because the plurality of particles are more easily tangled in the plurality of projecting portions.

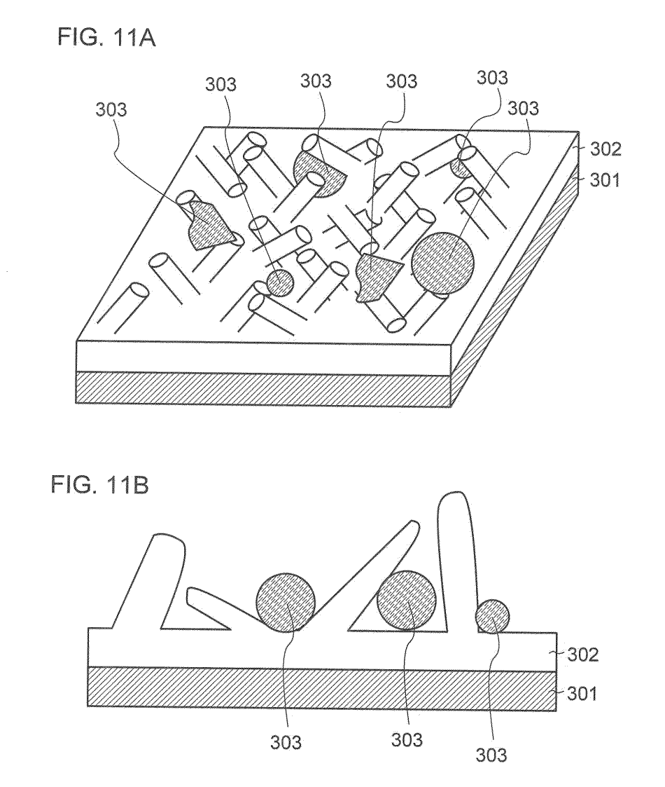

Although the shape of the plurality of particles in FIGS. 8A and 8B, FIGS. 9A and 9B, and FIGS. 10A and 10B is a cylinder shape, the shape of the plurality of particles can be a shape other than the cylinder shape as in FIGS. 11A and 11B.

Needless to say, the shape of the plurality of particles is not limited to the shapes in FIGS. 8A and 8B, FIGS. 9A and 9B, FIGS. 10A and 10B, and FIGS. 11A and 11B.

Note that FIG. 11A is a perspective view of an electrode, and FIG. 11B is a cross-sectional view of FIG. 11A.

The plurality of particles containing silicon as a main component may be any particle as long as the main component is silicon, and may contain another element (e.g., phosphorus, arsenic, carbon, oxygen, nitrogen, germanium, or a metal element) in addition to silicon.

Note that the plurality of particles containing silicon as a main component may have any crystallinity, and preferably have higher crystallinity because the characteristics of a power storage device are improved accordingly.

The plurality of particles may be a plurality of particles containing carbon as a main component.

In addition, the plurality of particles containing carbon as a main component may further contain another element.

The plurality of particles containing silicon as a main component, the plurality of particles containing carbon as a main component, or the like may be referred to as a plurality of particles containing an active material.

Note that a material containing silicon as a main component, a material containing carbon as a main component, or the like is an active material.

In addition, the active material is not limited to silicon and carbon as long as the material can occlude or release an alkali metal or an alkaline earth metal.

The main component of the plurality of particles and the main component of the plurality of projecting portions are preferably the same because the contact resistance between the plurality of particles and the plurality of projecting portions can be reduced.

The plurality of particles can be formed by crushing a desired material (e.g., silicon or carbon), for example.

Alternatively, with the use of any of the structures illustrated in FIGS. 1A and 1B, FIGS. 2A to 2C, FIGS. 3A and 3B, FIGS. 4A to 4C, FIGS. 5A and 5B, FIGS. 6A and 6B, and FIGS. 7A and 7B, a plurality of columnar particles can be formed by forming a plurality of projecting portions over a substrate for formation of the plurality of particles and shaving a surface of the substrate for formation of the plurality of particles.

Note that the method for forming the plurality of particles is not limited to the above methods.

Note that the plurality of particles are preferably applied by being mixed in a slurry.

The slurry is, for example, a mixture of a binder, a solvent, and the like.

A conductive additive may be mixed in the slurry.

Examples of the binder include, but are not limited to, polyvinylidene fluoride, starch, polyvinyl alcohol, carboxymethyl cellulose, hydroxypropyl cellulose, regenerated cellulose, diacetylcellulose, polyvinylchloride, polyvinylpyrrolidone, polytetrafluoroethylene, polyethylene, polypropylene, ethylene-propylene-diene monomer (EPDM), sulfonated EPDM, styrene-butadiene rubber, butadiene rubber, fluorine rubber, and polyethylene oxide. In addition, plural kinds of the binders can be used in combination.

Examples of the solvent include, but are not limited to, N-methylpyrrolidone (NMP) and lactic acid ester.

Examples of the conductive additive include, but are not limited to, a carbon material and a metal material.

Examples of the carbon material include, but are not limited to, graphite, carbon fiber, carbon black, acetylene black, and vapor grown carbon fiber (VGCF).

Examples of the metal material include, but are not limited to, copper, nickel, aluminum, and silver.

This embodiment can be implemented in combination with any of the other embodiments and an example as appropriate.

### Embodiment 7

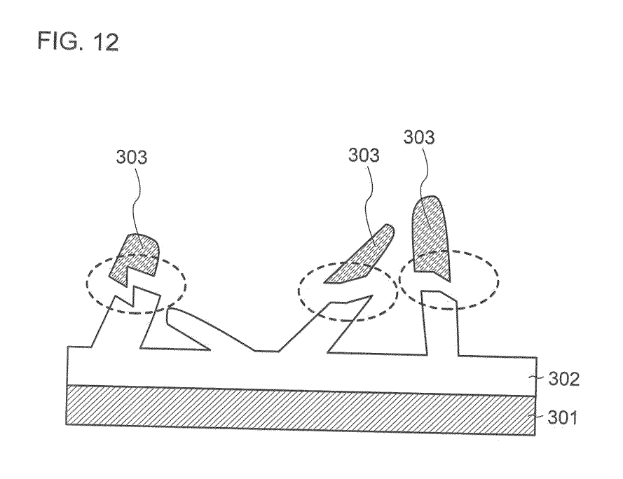

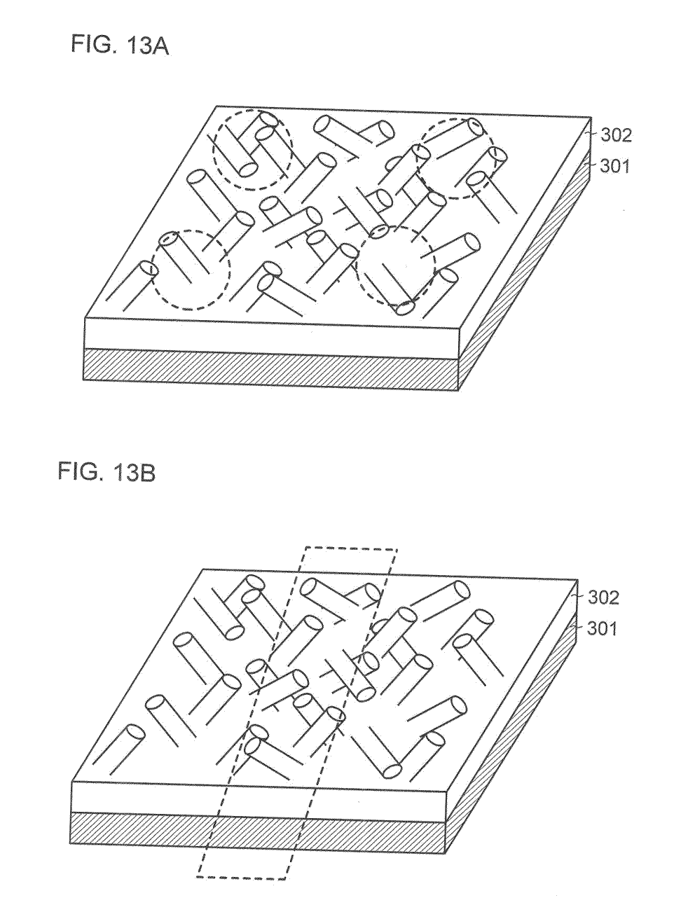

Although the plurality of particles are separately formed and arranged in Embodiment 6, the plurality of particles 303 are preferably formed by breaking the plurality of projecting portions as in FIG. 12.

The volume of an active material layer is not increased in the example of FIG. 12; however, the surface area of the active material layer can be increased because cross-sections of broken projecting portions are exposed. That is, dotted-line portions in FIG. 12 are exposed.

When the plurality of particles are separately prepared, cost is increased. By contrast, when the plurality of projecting portions are broken by pressure, cost is not increased. Thus, the example of FIG. 12 is preferable.

That is, in the example of FIG. 12, the surface area can be increased without an increase in cost.

Note that it is more preferable that the plurality of projecting portions be broken by pressure as in FIG. 12 and then a plurality of particles that are separately formed be arranged.

That is, it is more preferable to arrange both the plurality of particles that are formed by breaking some of the plurality of projecting portions and the plurality of particles that are separately formed.

Note that when a strong pressure is applied to all of the plurality of projecting portions, the roots of all of the plurality of projecting portions are broken and the plurality of projecting portions are lost in some cases.

Therefore, the pressure is preferably applied locally as in FIGS. 13A and 13B.

Note that FIGS. 13A and 13B illustrate examples in which the pressure is applied to positions surrounded by dotted lines.

That is, FIG. 13A is an example in which the pressure is applied locally in spots, and FIG. 13B is an example in which the pressure is applied locally in a linear form.

That is, in FIGS. 13A and 13B, it can be said that some of the plurality of projecting portions are broken locally.

In addition, it can be said that some of or all of the plurality of particles are fragments of the plurality of projecting portions.

Needless to say, the positions to which the pressure is applied are not limited to those in FIGS. 13A and 13B.

Although the case where the shapes of the plurality of projecting portions are uneven (irregular) is described, the example in this embodiment can be applied to a case where the shapes of the plurality of projecting portions are uniform (regular). This embodiment can be implemented in combination with any of the other embodiments and an example as appropriate.

### Embodiment 8

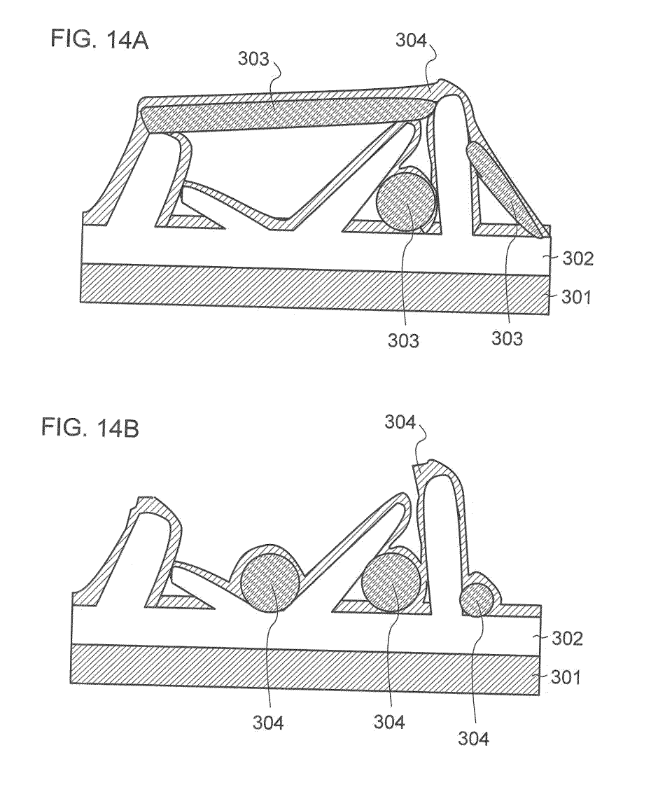

In order to fix the plurality of particles 303, after arranging the plurality of particles 303 over the plurality of projecting portions or in a space between the plurality of projecting portions, a protective film 304 containing an active material or a metal material is preferably formed over the layer 302 containing silicon as a main component and the plurality of particles 303 (FIGS. 14A and 14B).

That is, the layer 302 containing silicon as a main component and the plurality of particles 303 are preferably covered with the protective film 304 containing an active material or a metal material (FIGS. 14A and 14B).

Note that FIG. 14A is an example in which the protective film is formed in the structure of FIGS. 10A and 10B, and FIG. 14B is an example in which the protective film is formed in the structure of FIGS. 11A and 11B. Needless to say, the protective film may be formed in the structures of FIGS. 8A and 8B and FIGS. 9A and 9B.

Examples of a material for the protective film containing an active material include, but are not limited to, a material containing silicon as a main component and a material containing carbon as a main component.

Note that a material containing silicon as a main component, a material containing carbon as a main component, or the like is an active material.

The material containing silicon as a main component and the material containing carbon as a main component may contain an impurity.

Note that the protective film containing an active material can be formed by a CVD method, a sputtering method, an evaporation method, or the like.

An example of a material for the protective film containing a metal material is, without limitation, a material whose main component is tin, copper, nickel, or the like. The metal material may contain another element.

Note that even when a particle and a layer containing an active material are not in contact with each other, by using the protective film containing a metal material, the particle and a layer containing an active material can be electrically connected to each other via the protective film containing a metal material.

The protective film containing a metal material can be formed by, without limitation, an electrolytic precipitation method, a sputtering method, an evaporation method, or the like.

Here, the material for the protective film is preferably different from the material for the plurality of projecting portion and the plurality of particles.

This is because, by using different materials for the protective film and the plurality of projecting portions and the plurality of particles, both advantages of an active material containing silicon as a main component and an active material containing carbon as a main component can be taken.

For example, the active material containing silicon as a main component has the advantage that the capacity is larger than that of the active material containing carbon as a main component.

In addition, the active material containing carbon as a main component has the advantage that the volume expansion by occlusion of an alkali metal or an alkaline earth metal is less than that of the active material containing silicon as a main component.

Considering that the expansion can be reduced by forming the plurality of projecting portions, it is preferable that the active material containing carbon as a main component be used for the protective film and that the active material containing silicon as a main component be used for the plurality of projecting portions and the plurality of particles.

Alternatively, the active material containing carbon as a main component may be used for the plurality of projecting portions and the plurality of particles, and the active material containing silicon as a main component may be used for the protective film.

The protective film may be formed in the case where the plurality of particles are not arranged as in FIGS. 1A and 1B, FIGS. 2A to 2C, FIGS. 3A and 3B, FIGS. 4A to 4C, FIGS. 5A and 5B, FIGS. 6A and 6B, and FIGS. 7A and 7B.

Even when the plurality of particles are not arranged, by forming the protective film containing an active material, the volume of the active material can be increased.

Even when the plurality of particles are not arranged, by forming the protective film containing a metal material, the conductivity of the electrode can be increased.

This embodiment can be implemented in combination with any of the other embodiments and an example as appropriate.

### Embodiment 9

A silicide layer may be formed between the current collector 301 and the layer 302 containing silicon as a main component.

In order to form the silicide layer, the current collector may be formed using a material which can form silicide, such as titanium, nickel, cobalt, or tungsten, and heat treatment may be performed at a predetermined temperature.

This embodiment can be implemented in combination with any of the other embodiments and an example as appropriate.

### Embodiment 10

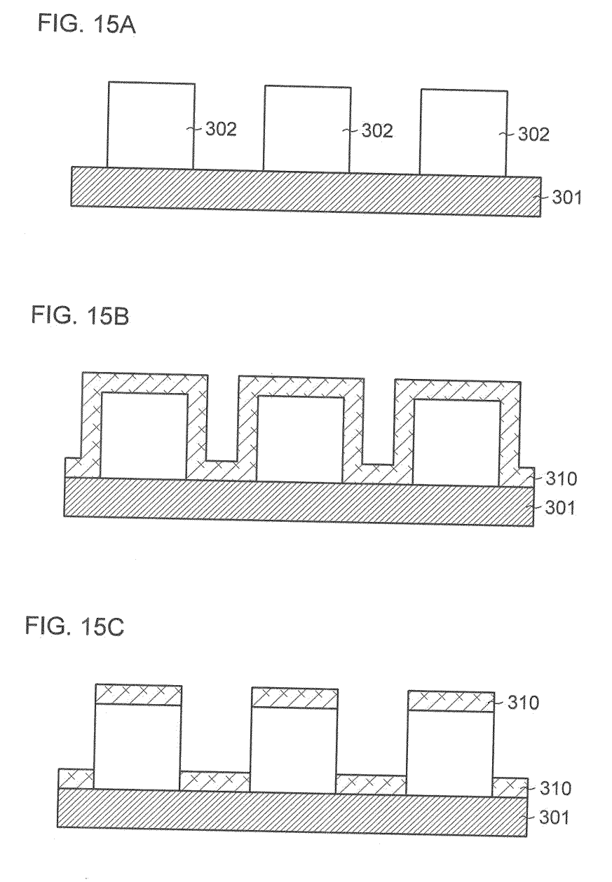

An example of a method for forming an active material which is arranged in a space between projecting portions will be described with reference to FIGS. 15A to 15C.

The state of FIG. 15A is the same as that of FIG. 2C.

A layer 310 containing silicon as a main component is formed by a CVD method, a sputtering method, an evaporation method, or the like, so that the active material arranged in a space between the projecting portions can be formed (FIG. 15B). The method for forming the layer 310 containing silicon as a main component is not limited to a CVD method, a sputtering method, an evaporation method, or the like.

Note that when the thickness of the layer 302 containing silicon as a main component, which is illustrated in FIGS. 15A to 15C is large, the layer 310 containing silicon as a main component cannot cover side surfaces of a layer 302 containing silicon as a main component in some cases (FIG. 15C).

Note that the state of FIG. 15B is the same as the state where the protective film described in Embodiment 8 is formed in the structure of FIGS. 1A and 1B. A layer containing carbon as a main component or a metal layer may be used instead of the layer 310 containing silicon as a main component.

This embodiment can be implemented in combination with any of the other embodiments and an example as appropriate.

### Embodiment 11

A structure of a power storage device will be described.

The power storage device may be any power storage device including at least a pair of electrodes and an electrolyte between the pair of electrodes.

In addition, the power storage device preferably includes a separator between the pair of electrodes.

The power storage device can be of various types such as, without limitation, a coin type, a square type, or a cylindrical type.

A structure may be employed in which a separator and an electrolyte interposed between a pair of electrodes are rolled up.

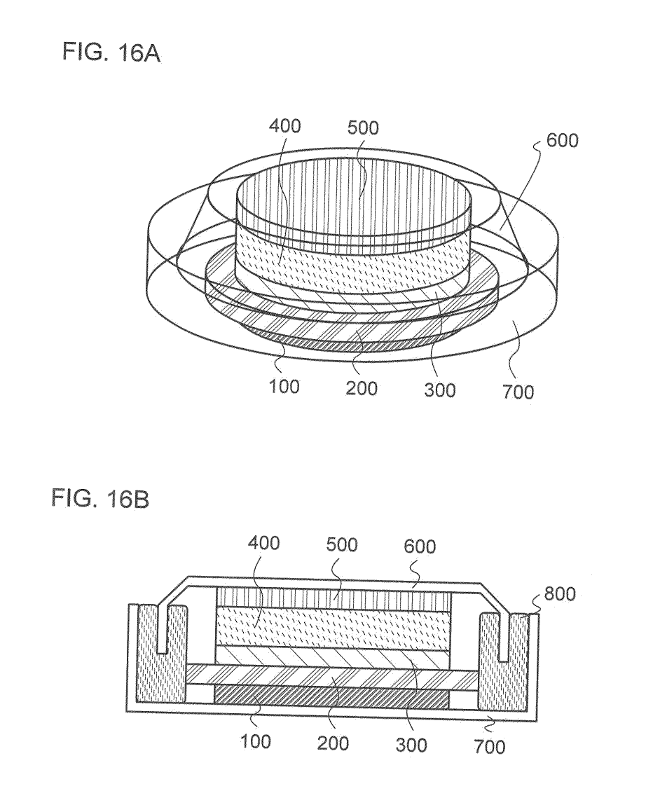

FIGS. 16A and 16B illustrate an example of a coin-type power storage device.

FIG. 16A is a perspective view of the power storage device, and FIG. 16B is a cross-sectional view of FIG. 16A.

In FIGS. 16A and 16B, a separator 200 is provided over a first electrode 100, a second electrode 300 is provided over the separator 200, a spacer 400 is provided over the second electrode 300, and a washer 500 is provided over the spacer 400.

Note that at least an electrolyte is provided between the first electrode 100 and the second electrode 300.

In addition, the separator 200 is impregnated with the electrolyte.

Further, the first electrode 100, the separator 200, the second electrode 300, the spacer 400, the washer 500, and the electrolyte are arranged inside a region surrounded by a first housing 600 and a second housing 700.

In addition, the first housing 600 and the second housing 700 are electrically isolated from each other by an insulator 800.

Note that the positions of the first electrode 100 and the second electrode 300 are interchangeable in FIGS. 16A and 16B.

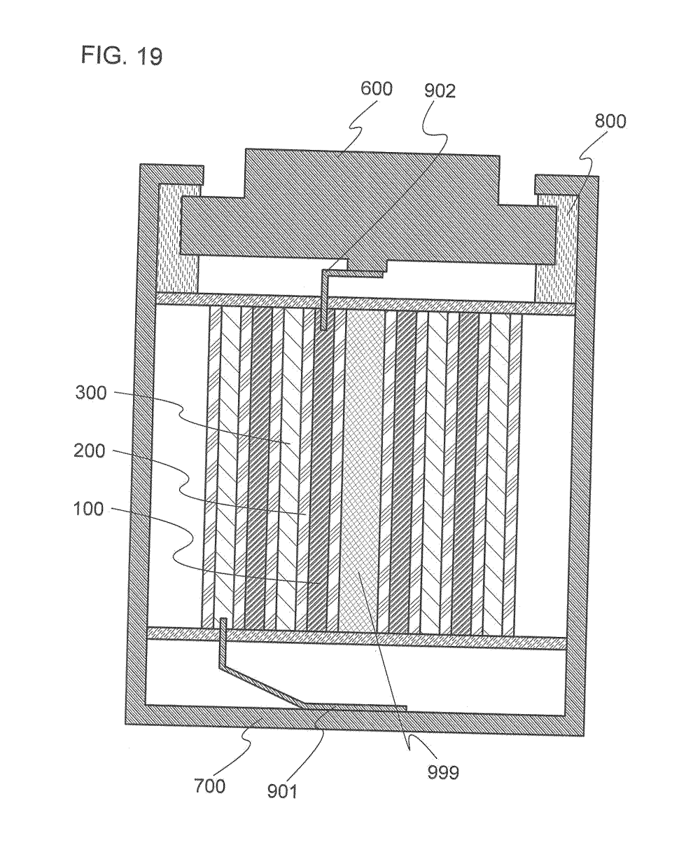

FIG. 19 illustrates an example different from the example of FIGS. 16A and 16B.

In FIG. 19, the separator 200 is interposed between the first electrode 100 and the second electrode 300.

In addition, a stack of the first electrode 100, the separator 200, and the second electrode 300 is rolled around a stick 999.

The first electrode 100 is electrically connected to the first housing 600 via a lead line 902.

The second electrode 300 is electrically connected to the second housing 700 via a lead line 901.

In addition, the first housing 600 and the second housing 700 are electrically isolated from each other by the insulator 800.

Note that the positions of the first electrode 100 and the second electrode 300 are interchangeable in FIG. 19.

Materials and the like of the components are described below.

[symbol]

Electrolyte

[symbol]

As the electrolyte, for example, a water-insoluble medium and a salt which is dissolved in the water-insoluble medium (e.g., an alkali metal salt or an alkaline earth metal salt) may be used.

Note that the electrolyte is not limited to the above electrolyte, but may be any electrolyte as long as the electrolyte has a function of conducting a reactive material (e.g., alkali metal ions or alkaline earth metal ions).

In addition, the electrolyte can be of various types such as, without limitation, a solid type, a liquid type, a gas type, or a gel-like type.

[symbol]

First Electrode

[symbol]

The first electrode includes a current collector and a layer containing an alkali metal or an alkaline earth metal. The layer containing an alkali metal or an alkaline earth metal is positioned on the separator side.

The current collector can be formed using a conductive material.

Examples of the conductive material include, but are not limited to, a metal, carbon, and a conductive resin.

Examples of the metal include, but are not limited to, titanium, nickel, copper, zirconium, hafnium, vanadium, tantalum, chromium, molybdenum, tungsten, cobalt, and an alloy of any of these metals.

For example, the layer containing an alkali metal or an alkaline earth metal can be formed using, without limitation, a material represented by a general formula AₓM_{y}PO_{z} (x≧0, y>0, z>0), a general formula AₓM_{y}O_{z} (x≧0, y>0, z>0), a general formula AᵣM_{y}SiO_{z} (x≧0, y>0, z>0), or the like.

Note that A in the formulas represents an alkali metal or an alkaline earth metal.

Examples of the alkali metal include, but are not limited to, lithium, sodium, and potassium.

Examples of the alkaline earth metal include, but are not limited to, beryllium, magnesium, calcium, strontium, and barium.

In addition, M in the formulas represents a transition metal.

Examples of the transition metal include, but are not limited to, iron, nickel, manganese, and cobalt.

Note that M may represent two or more kinds of metals such as, without limitation, a combination of iron and nickel, a combination of iron and manganese, or a combination of iron, nickel, and manganese.

In addition, a conductive additive containing carbon as a main component may be added to the layer containing an alkali metal or an alkaline earth metal.

Alternatively, as the layer containing an alkali metal or an alkaline earth metal, an alkali metal film, an alkaline earth metal film, a film in which an alkali metal or an alkaline earth metal is added to silicon, a film in which an alkali metal or an alkaline earth metal is added to carbon, or the like may be used.

[symbol]

Separator

[symbol]

When the electrolyte is a liquid, an insulating separator is preferably provided.

Examples of the separator include, but are not limited to, paper, nonwoven fabric, glass fiber, and synthetic fiber.

Examples of the synthetic fiber include, but are not limited to, nylon, vinylon, polypropylene, polyester, and acrylic.

[symbol]

Second Electrode

[symbol]

As the second electrode, the electrode described in any of Embodiments 1 to 10 may be used.

[symbol]

Spacer, washer, first housing, second housing

[symbol]

Any conductive material can be used.

In particular, SUS (stainless steel) or the like is preferably used.

[symbol]

Insulator

[symbol]

Any insulating material can be used.

In particular, polypropylene or the like is preferably used.

This embodiment can be implemented in combination with any of the other embodiments and an example as appropriate.

### Embodiment 12

Electric devices including power storage devices will be described.

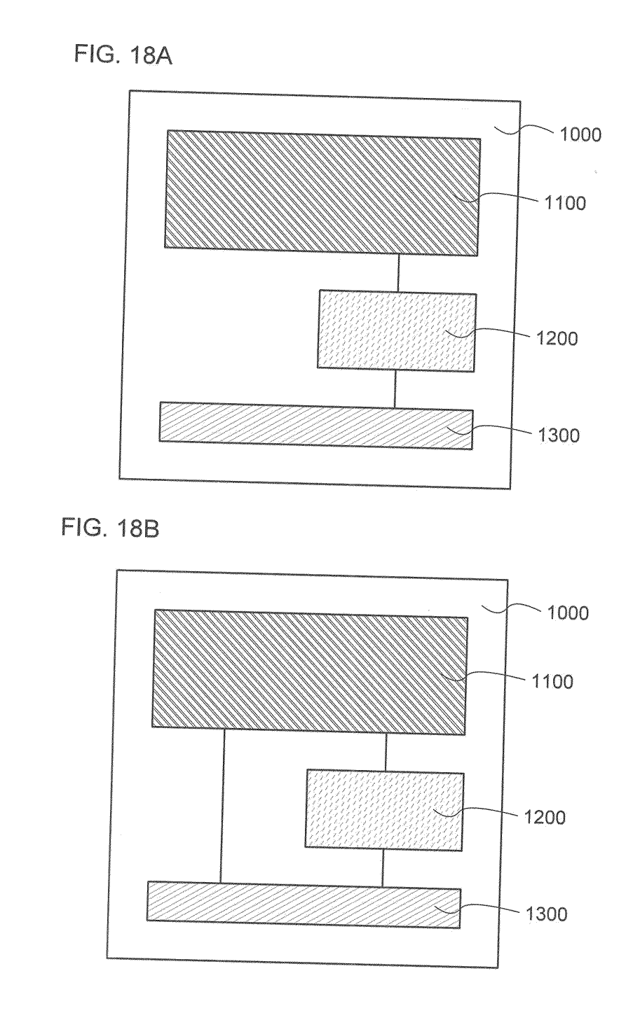

In FIGS. 18A and 18B, an electric device 1000 includes at least a power load portion 1100, a power storage device 1200 electrically connected to the power load portion 1100, and a circuit 1300 including an antenna, which is electrically connected to the power storage device 1200.

In FIG. 18B, the power load portion 1100 and the circuit 1300 including an antenna are electrically connected to each other.

Note that in FIGS. 18A and 18B, the electric device 1000 may include a component other than the power load portion 1100, the power storage device 1200, and the circuit 1300 including an antenna.

In addition, the electric device 1000 is a device which has at least a function of being driven by electric energy.

Examples of the electric device 1000 include an electronic device and an electric propulsion vehicle.

Examples of the electronic device include, but are not limited to, a camera, a mobile phone, a mobile information terminal, a mobile game machine, a display device, and a computer.

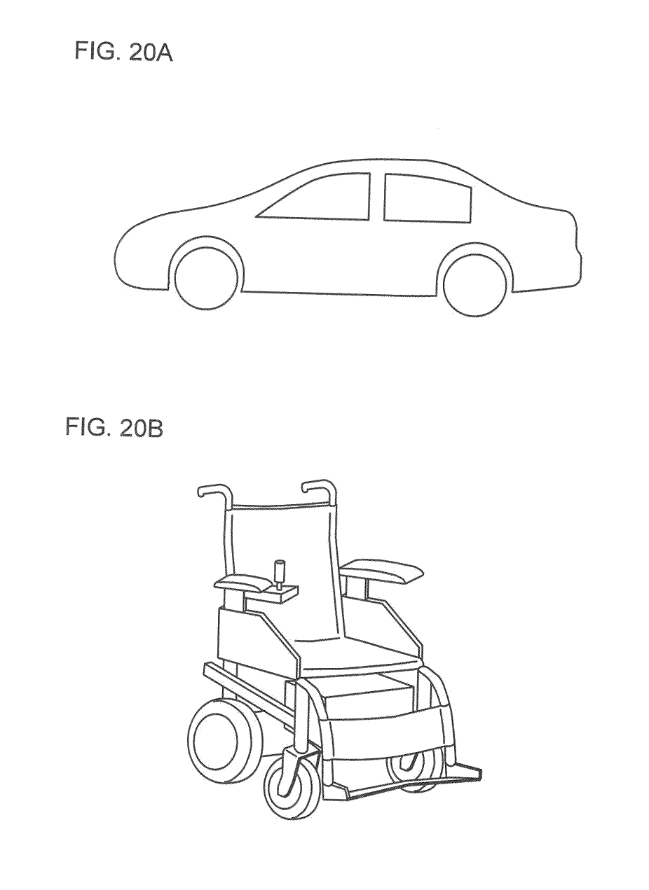

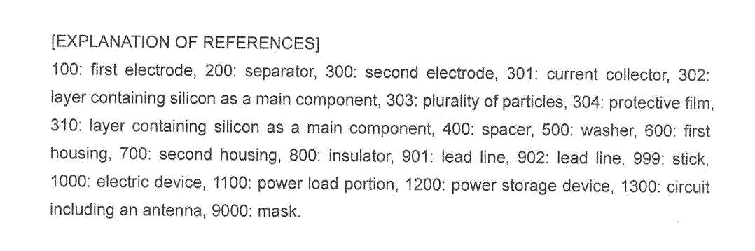

Examples of the electric propulsion vehicle include, but are not limited to, an automobile car which is propelled by utilizing electric energy (FIG. 20A), a wheelchair which is propelled by utilizing electric energy (FIG. 20B), a motor bicycle which is propelled by utilizing electric energy, and a train which is propelled by utilizing electric energy.

The power load portion 1100 is, for example, a driver circuit or the like in the case where the electric device 1000 is an electronic device, or a motor or the like in the case where the electric device 1000 is an electric propulsion vehicle.

The power storage device 1200 may be any device which has at least a function of storing power.

Note that as the power storage device 1200, the power storage device described in any of the other embodiments or an example is particularly preferably used.

The circuit 1300 including an antenna includes at least an antenna.

In addition, the circuit 1300 including an antenna preferably includes a signal processing circuit which processes a signal received by the antenna and transmits the signal to the power storage device 1200.

Here, FIG. 18A illustrates an example having a function of performing wireless charge, and FIG. 18B illustrates an example having a function of transmitting and receiving data in addition to the function of performing wireless charge.

In the case of having the function of transmitting and receiving data as in FIG. 18B, the circuit 1300 including an antenna preferably includes a demodulation circuit, a modulation circuit, a rectifier circuit, and the like.

Note that in each of FIGS. 18A and 18B, between the power storage device 1200 and the power load portion 1100, by providing a power supply circuit which converts a current supplied from the power storage device 1200 or a voltage applied from the power storage device 1200 into a fixed voltage, overcurrent in the power load portion 1100 can be prevented from flowing.

In addition, in order to prevent backflow of current, a backflow prevention circuit is preferably provided between the power storage device 1200 and the circuit 1300 including an antenna.

As the backflow prevention circuit, for example, a diode or the like can be used.

When a diode is used as the backflow prevention circuit, the diode is preferably connected so that a forward bias is applied in a direction from the circuit 1300 including an antenna to the power storage device 1200.

This embodiment can be implemented in combination with any of the other embodiments and an example as appropriate.

### Example 1

A sample 1 and a comparative sample each of which is a power storage device having a structure similar to that of FIGS. 16A and 16B were fabricated.

Note that conditions of the sample 1 and the comparative sample are the same except for a material for the second electrode 300.

[symbol]

Same Conditions of Sample 1 and Comparative Sample

[symbol]

As the first electrode 100, a lithium electrode was used, which is a reference electrode.

For the separator 200, polypropylene was used.

As the electrolyte, an electrolyte in which LiPF₆ was dissolved in a mixed solvent of ethylene carbonate (EC) and diethyl carbonate (DEC) (EC:DEC=1:1) was used.

For the spacer 400, the washer 500, the first housing 600, and the second housing 700, SUS was used.

### Fabrication of Second Electrode 300 of Sample 1

As the current collector, a titanium sheet (thickness: 100 μm) was prepared.

Then, crystalline silicon was deposited over the titanium sheet by a thermal CVD method.

Conditions of the thermal CVD method were as follows. Silane (SiH₄) was used as a source gas, the flow rate of the silane was 300 sccm, the pressure for deposition was 20 Pa, and the temperature of a substrate (the temperature of the titanium sheet) was 600° C.

The thickness including projecting portions was 3.5 μm.

Note that before deposition of the crystalline silicon, the temperature of the substrate (the titanium sheet) was increased while a small amount of helium was introduced into a deposition chamber.

The deposition chamber of a thermal CVD apparatus was formed of quartz.

[symbol]

Fabrication of Second Electrode 300 of Comparative Sample

[symbol]

As the current collector, a titanium sheet (thickness: 100 μm) was prepared.

Then, amorphous silicon was deposited over the titanium sheet by a plasma CVD method, and the amorphous silicon was crystallized to form crystalline silicon.

Conditions of the plasma CVD method were as follows. Silane (SiH₄) and phosphine (PH₃) diluted with hydrogen (5% dilution) were used as source gases, the flow rate of the silane was 60 sccm, the flow rate of the phosphine diluted with hydrogen was 20 sccm, the pressure for deposition was 133 Pa, and the temperature of a substrate (the temperature of the titanium sheet) was 280° C.

The thickness of the amorphous silicon was 3 μm.

Next, the amorphous silicon was heated in an argon atmosphere at 700° C. for six hours, so that the crystalline silicon was formed.

### Shape and Discussion of Second Electrode 300 of Sample 1

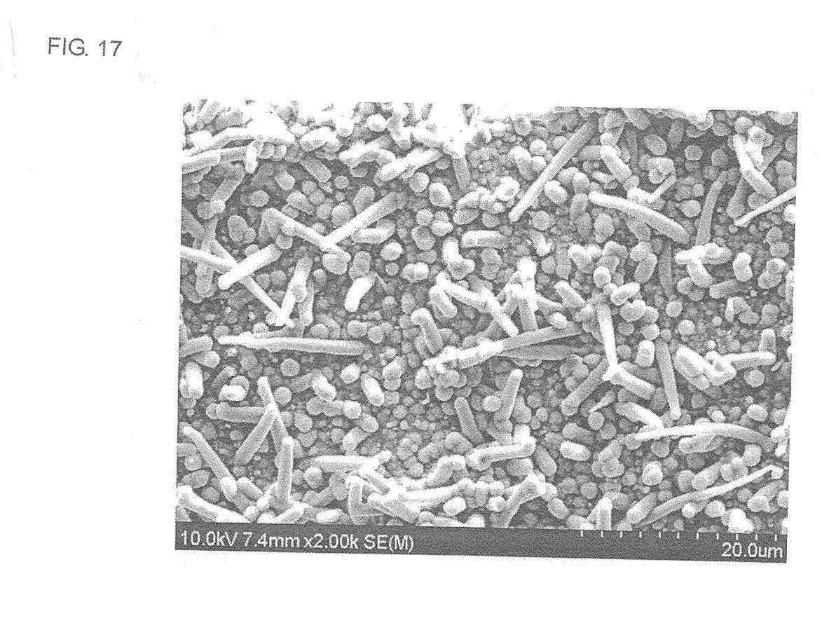

FIG. 17 shows a scanning electron micrograph (a SEM photograph) of a surface of the second electrode 300 of the sample 1 (a surface of the crystalline silicon).

From FIG. 17, it can be found that columnar crystals were randomly grown from the surface of the crystalline silicon and that whiskers were formed.

Note that a whisker means a whisker-like projecting portion.

FIGS. 7A and 7B correspond to schematic views of FIG. 17.

By contrast, when a surface of the second electrode 300 of the comparative sample was observed by the SEM, a whisker was not observed.

The sample 1 and the comparative sample are different from each other. The comparative sample was fabricated using a plasma CVD method, and the sample 1 was fabricated using a thermal CVD method.

A monitor 1 was fabricated over a quartz substrate and a monitor 2 was fabricated over a silicon wafer. In each of the monitors, crystalline silicon was deposited under the same conditions as the sample 1. However, a whisker was not observed.

Therefore, it is found that the crystalline silicon in FIG. 17 can be obtained by depositing crystalline silicon over titanium by a thermal CVD method.

In order to confirm reproducibility, a reproductive experiment was conducted in which crystalline silicon was deposited over a titanium sheet under the same conditions as the sample 1; as a result, whiskers were observed again.

Further, a titanium film with a thickness of 1 μm was formed over a glass substrate and crystalline silicon was deposited over the titanium film by a thermal CVD method; as a result, whiskers were observed again.

Note that conditions for deposition of the crystalline silicon over the titanium film with a thickness of 1 μm were as follows. The temperature of the glass substrate was 600° C., the flow rate of silane (SiH₄) was 300 sccm, and the pressure for deposition was 20 Pa.

As an additional experiment, crystalline silicon was deposited over a nickel film instead of the titanium film by a thermal CVD method; as a result, whiskers were observed.

[symbol]

Comparison of Characteristics of Sample 1 and Comparative Sample

[symbol]

The capacities of the sample 1 and the comparative sample were measured using a charge-discharge measuring instrument.

For the measurement of charge and discharge capacities, a constant current mode was used.

In the measurement, charge and discharge were performed with a current of 2.0 mA.

In addition, the upper limit voltage was 1.0 V, and the lower limit voltage was 0.03 V.

The temperature in the measurement was room temperature.

Note that the room temperature means that the samples were not intentionally heated or cooled.

The measurement results show that initial characteristics of the discharge capacities per unit volume of active material layers of the sample 1 and the comparative sample were 7300 mAh/cm³ and 4050 mAh/cm³, respectively. Here, the thickness of the active material layer of the sample 1 was 3.5 μm, the thickness of the active material layer of the comparative sample was 3.5 μm, and the capacities were calculated. Note that each of the capacities given here is a discharge capacity of lithium.

Therefore, it is found that the capacity of the sample 1 is approximately 1.8 times as large as the capacity of the comparative sample.

This application is based on Japanese Patent Application serial No. 2010-123139 filed with Japan Patent Office on May 28, 2010, the entire contents of which are hereby incorporated by reference.

1. A power storage device comprising:
a first electrode;
a second electrode; and
an electrolyte provided between the first electrode and the second electrode,
wherein the second electrode includes an active material layer which includes a plurality of projecting portions containing an active material.

2. The power storage device according to claim 1, wherein the active material layer includes a plurality of particles containing an active material, which are arranged over and between the plurality of projecting portions.

3. The power storage device according to claim 2, wherein some of the plurality of particles are particles formed by breaking some of the plurality of projecting portions.

4. The power storage device according to claim 2, wherein the plurality of projecting portions and the plurality of particles are covered with a protective film containing an active material or a metal material.

5. The power storage device according to claim 1, wherein shapes of the plurality of projecting portions are uneven.

6. The power storage device according to claim 1, wherein some of the plurality of projecting portions are broken locally.

7. The power storage device according to claim 1, further comprising a surface containing an active material between the plurality of projecting portions.

8. An electric device comprising the power storage device according to claim 1.

9. An electrode used in a power storage device, comprising:
an active material layer which includes a plurality of projecting portions containing an active material.

10. The electrode according to claim 9, wherein the active material layer includes a plurality of particles containing an active material, which are arranged over and between the plurality of projecting portions.

11. The electrode according to claim 10, wherein some of the plurality of particles are particles formed by breaking some of the plurality of projecting portions.

12. The electrode according to claim 10, wherein the plurality of projecting portions and the plurality of particles are covered with a protective film containing an active material or a metal material.

13. The electrode according to claim 9, wherein shapes of the plurality of projecting portions are uneven.

14. The electrode according to claim 9, wherein some of the plurality of projecting portions are broken locally.

15. The electrode according to claim 9, further comprising a surface containing an active material between the plurality of projecting portions.
